(19) United States
(12) Patent Application Publication
(10) Pub. No.: US 2018/0170111 A1
(43) Pub. Date: Jun. 21, 2018

(54) SYSTEM AND TIRE WITH AN ASYMMETRIC PLY LINE

(71) Applicant: The Goodyear Tire & Rubber Company, Akron, OH (US)

(72) Inventors: Paul Benoit JOUBERT, Fort Wallis (LU); Jerome BOURSIN, Aspelt (LU); Francois ZIMMER, Lexy (FR); Bodo AHRENS, Trier (DE); Jean-Louis Marie Felicien THOMAS, Waltzing (BE); Samy Laroussi MZABI, Ettelbruck (LU); Edwin DEERENBERG, Ettelbruck (LU)

(21) Appl. No.: 15/842,926

(22) Filed: Dec. 15, 2017

Related U.S. Application Data
(60) Provisional application No. 62/435,874, filed on Dec. 19, 2016.

(51) Int. Cl. B60C 9/17; B60C 15/024; B60C 9/30; B60C 11/03

(52) U.S. Cl. CPC B60C 9/17; B60C 15/024; B60C 9/22; B60C 11/0332; B60C 9/30

(57) ABSTRACT

A tire has an axis of rotation, a cavity shape, a crown portion, a pair of beads, a tread, a pair of sidewalls, a pair of shoulder portions, and a carcass including a plurality of plies. Each ply has a cord. The tire is characterized by a path of the cord in at least one ply defining a ply line.

### TECHNICAL FIELD

The present invention relates to an improved radial ply tire, and, more specifically, to an improved ply line of a radial ply passenger or truck tire.

### BACKGROUND OF THE INVENTION

It is desirable for a tire tread to bear against the ground uniformly along its width, so that the load on the tire is evenly distributed. When a tire is loaded, the portion of the tire's sidewalls near the ground bulge outward. If the tire is stiff along the shoulders, the sidewall bulge causes the center of the tread in contact with the ground to lift off the ground or merely to lose pressure against the ground. The stiff tire sidewall close to the shoulder acts like a lever, and the shoulder against the ground acts as its fulcrum. This “tread-lift” is aggravated by high bending stiffness of the shoulder area, and by a small ply line radius (e.g., sharp bend) in the shoulder.

The resulting bending stresses from the sidewalls to the tread cause inward buckling and lifting of the center portion of the tread off the ground, causing the center portion of the tread to bear little or none of the tire's load, which produces several issues. It degrades vehicle handling characteristics, especially in cornering. It increases tread wear near the shoulders and increases material fatigue under the tread due to the cycling of the bending stresses upon tire rotation, and hence shortens tire life or durability. Tread-lift is a problem whether the tread center actually lifts off the ground or merely loses pressure against the ground.

“Heavy handling” refers to severe driving conditions due to aggressive driving by a driver, such as sharp cornering and/or racing conditions. For good heavy handling performance, the tire shoulder area needs to have heavier gauge (e.g., thicker) rubber in both the tire shoulder and upper sidewall areas. This is required to provide a high tangential stiffness (e.g., resistance of tread rotation around tire axis relative to the beads) and a better durability in heavy handling. However, a heavy gauge leads to high bending stiffness especially in the shoulder area where the ply line radius is rather small. Hence, heavy handling tires are prone to tread-lift.

The tread-lift issue has been conventionally mitigated by “decoupling grooves” in the tread in the tire shoulder areas, by increasing the radii of the adjacent contour-defining curves near the shoulder area, and by rendering the adjacent contour-defining curves non-tangential with each other at their meeting point. While alleviating the tread-lift issue, incorporating decoupling grooves in the shoulder areas reduces tangential stiffness and reduces tire in heavy handling tires.

### SUMMARY OF THE PRESENT INVENTION

A tire in accordance with the present invention has an axis of rotation, a cavity shape, a crown portion, a pair of beads, a tread, a pair of sidewalls, a pair of shoulder portions, and a carcass including a plurality of plies. Each ply has a cord. The tire is characterized by a path of the cord in at least one ply defining a ply line.

According to another aspect of the tire, the beads are both at the same radial position related to the axis of rotation with the pair of sidewalls being asymmetric.

According to still another aspect of the tire, the pair of shoulder portions have an asymmetric construction and the cavity shape has a symmetric construction.

According to yet another aspect of the tire, the tire is cured from quasi-symmetric uncured tire in an asymmetric mold with a symmetric mold ring and sidewall plates having different shapes.

According to still another aspect of the tire, the crown portion moves laterally when the tire is mounted on a symmetric rim and inflated.

According to yet another aspect of the tire, the ply line is asymmetric and one shoulder portion may have a radial position different from a radial position of the other shoulder portion.

A system in accordance with the present invention includes a substantially symmetric green tire having an axis of rotation, an asymmetric curing mold, curing the substantially symmetric tire with the asymmetric mold to produce a cured tire such that a crown area of the cured tire moves laterally when the cured tire is mounted on a symmetrical rim and is inflated.

According to another aspect of the system, an axial centerline of the crown area is axially offset a predetermined distance from an axial centerline of a rim on which the cured tire is mounted.

According to still another aspect of the system, the predetermined distance increases when the cured tire changes from an unloaded condition to a loaded condition.

According to yet another aspect of the system, the cured tire is free of grooves in shoulder areas of the crown area.

### BRIEF DESCRIPTION OF THE DRAWINGS

Reference will be made in detail to the example embodiments of the present invention, examples of which are illustrated in the accompanying drawings. The drawings are intended to be illustrative, not limiting. Certain elements in some of the drawings may be illustrated not-to-scale for illustrative clarity. The cross-sectional views presented herein may be in the form “near-sighted” cross-sectional views, omitting certain background lines that would otherwise be visible in a true cross-sectional view. The structure, operation, and advantages of the present invention will become further apparent upon consideration of the following description taken in conjunction with the accompanying drawings, wherein:

FIG. 1 shows a schematic cross-section of a system in accordance with the present invention;

FIG. 2 shows a schematic cross-section of another aspect of the system of FIG. 1;

FIG. 3 shows a schematic cross-section of still another aspect of the system of FIG. 1; and

FIG. 4 shows a schematic cross-section of yet another aspect of the system of FIG. 1 shows a schematic cross-section of a portion of the tire of FIG. 1.

### DEFINITIONS

“Axial” and “axially” means the directions that are parallel to the tire axis.

“Bead” means an annular tensile member that is associated with holding the tire to the rim. The beads are wrapped by ply cords and shaped, with or without other reinforcement elements such as flippers, chippers, apexes or fillers, toe guards and chafers.

“Belt Structure” or “ Belts” means at least two annular layers or plies of parallel cords, woven or unwoven, underlying the tread, unanchored to the bead, and having both left and right cord angles in the range from 0° to 45° with respect to the equatorial plane of the tire.

“Carcass” means the tire structure apart from the belt structure, tread and underlay over the plies, but including the beads.

“Carcass cord” means ply cord.

“Circumferential” means directions extending along the perimeter of the surface of the annular tread perpendicular to the axial direction.

“Cord” means one of the reinforcement strands of which the plies in the tire are comprised.

“Equatorial Plane” or “EP” means the plane perpendicular to the tire's axis of rotation and passing through the center of its tread.

“Lateral” means in the direction parallel with the tire axis.

“Loaded” used as an adjective for any parameter refers to that parameter for a tire that is loaded, (e.g., inflated, mounted on a passenger or small truck, and resting on a surface). The tread profile of a passenger or small truck tire is generally flat in the loaded condition.

“Meridional” refers to a tire profile cut along a plane that includes the tire's rotational axis.

“Ply” means a layer of rubber-coated parallel cords.

“Quasi-symmetric” means asymmetric.

“Radial” means in a direction orthogonal to the tire axis.

“Radial Ply Tire” means a belted or circumferentially-restricted pneumatic passenger or small truck tire in which at least one ply has cords which extend from bead to bead and are laid at cord angles between 45° and 90° with respect to the equatorial plane of the tire. The term tire within the context of the present invention excludes motorcycle tires.

“Shoulder” means the region where the sidewall meets the tread edge.

“Shoulder Region” means the upper portion of sidewall just below the tread edge. The shoulder region of a passenger or small truck tire has a cavity radius of up to 60 millimeters (mm) The shoulder region is the part of the tire under this cavity radius and between two planes perpendicular to the ply and passing through the borders of this cavity radius.

“Sidewall” is the portion of a tire between the tread and the bead.

“Tire footprint” means the interface region in contact with the road surface while rotating under load. There is a vertical component acting in the “Z” direction, a longitudinal component acting in the “X” direction, and a lateral component acting in the “Y” direction.

“Unloaded” used as an adjective for any parameter refers to that parameter for a tire that is unloaded, (e.g., inflated and not resting on a surface). The tread profile of a passenger or small truck tire is generally flat in the unloaded condition.

### DETAILED DESCRIPTION OF EXAMPLES OF THE PRESENT INVENTION

A conventional system, tire, and method is described in U.S. Pat. No. 6,941,991, incorporated herein by reference in its entirety. A system, tire, and method in accordance with the present invention begins as a substantially symmetrical green carcass. The tire may be cured in an asymmetrical mold thereby forming geometrically asymmetric sidewalls. The tire may then be inflated to produce asymmetrical behavior while rotating and loaded. Such behavior may generate an unbalance in carcass ply tension producing a beneficial asymmetrical force distribution within the tire footprint.

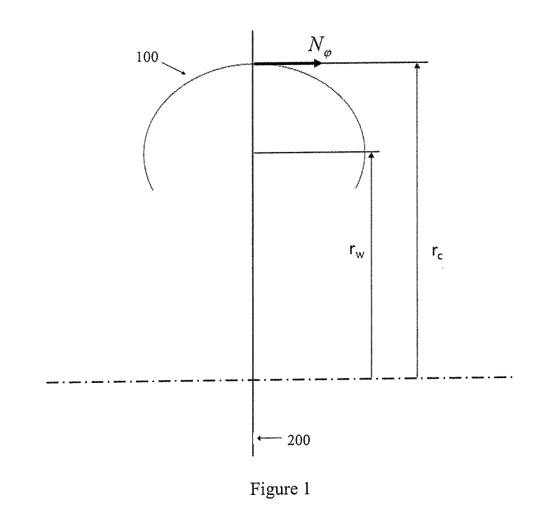

As seen in FIG. 1, the tension in the membrane, or carcass ply 100, may be related to the air pressure (P) within the membrane by the below equation. The meridional tension Nφ may be expressed at the center line 200 of the tire.

$$N ϕ = \frac{P ( {r}_{c}^{2} - {r}_{w}^{2} )}{2 {r}_{c}}$$

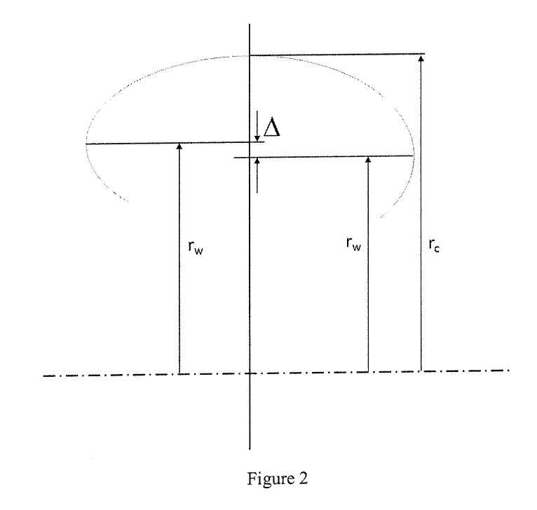

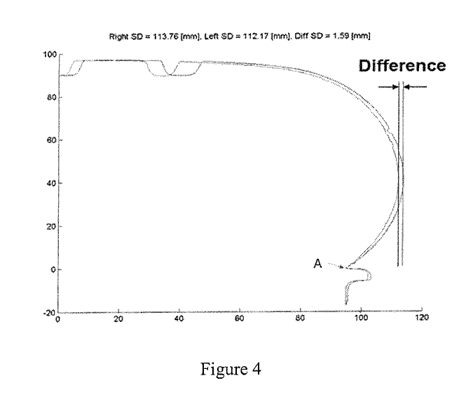

In order for a full belt package of the tire to move laterally, the full belt package may have a cured maximum width radius r_{w} radially different by the distance between the two sidewalls (FIG. 2). A radial inequality of tension during the inflation process will move laterally the full belt package and crown area. The difference between the two radii r_{w1}, r_{w2}, may be obtained by curing the tire in an asymmetric mold. Asymmetry lying in different levels between the two sidewalls and/or different curvatures between the two sidewalls. The lateral change in position may be measured by comparing the contour of the tire mounted on a symmetric rim at different inflation pressures (e.g., Pᵢ=0 bar) (FIG. 4).

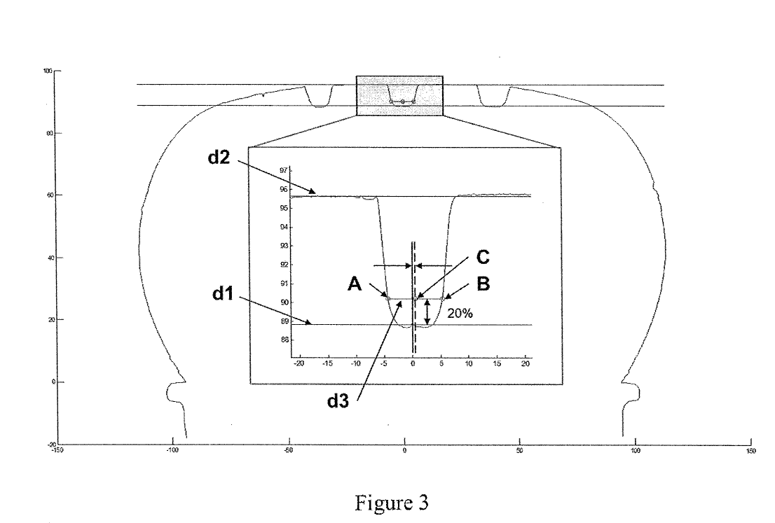

In FIG. 3 measurement of the lateral displacement of the tire is shown. The reference point (C) may be laterally located during different steps of the inflating process. The line (d1) may be a horizontal line intersecting the radially inner most position of the tread at the center line 100. The line (d2) may be a horizontal line intersecting the radially outermost position of the tread proximate the center line 100. The line (d3) may be a horizontal line positioned at 20% of the radial distance between line (d1) and line (d2). The reference point (A) may be the intersection of the line (d3) and one sidewall of the center groove. The reference point (B) may be the intersection of the line (d3) and the axial center of the center groove. The reference point (C) may be the midpoint between reference points (A) and (B).

The axial position of reference point (C), as shown in FIG. 4, may be monitored for each inflation pressure step. The lateral change of position of one of the sidewalls may be determined Also, the maximum width of the sidewalls during the inflation pressure process may be measured. The overall lateral change of position of the crown area may thereby be observed.

While the present invention has been described in combination with examples thereof, it is evident that many alternatives, modifications, and/or variations will be apparent to those skilled in the art in light of the foregoing teachings. Accordingly, the present invention is intended to embrace all such alternatives, modifications, and variations as fall within the spirit and scope of the following appended claims.

What is claimed:

1. A tire having an axis of rotation, a cavity shape, a crown portion, a pair of beads, a tread, a pair of sidewalls, a pair of shoulder portions, and a carcass including a plurality of plies, each ply having a cord, the tire being characterized by a path of the cords in at least one ply defining a ply line.

2. The tire as set forth in claim 1 wherein the beads are both at the same radial position related to the axis of rotation with the pair of sidewalls being asymmetric.

3. The tire as set forth in claim 2 wherein the pair of shoulder portions have an asymmetric construction and the cavity shape is symmetric.

4. The tire as set forth in claim 2 wherein the tire is cured from a quasi-symmetric uncured tire in an asymmetric mold with a symmetric mold ring and sidewall plates having different shapes.

5. The tire as set forth in claim 4 wherein the crown portion moves laterally when the tire is mounted on a symmetrical rim and inflated.

6. The tire as set forth in claims 1 to 3 wherein the ply line is asymmetric and one shoulder portion may have a radial position different from a radial position of the other shoulder portion.
